(19) United States
(12) Patent Application Publication
(10) Pub. No.: US 2025/0334223 A1
(43) Pub. Date: Oct. 30, 2025

(54) BASE-OVERTURN-PREVENTING FIXATION BRACKET

(71) Applicant: OXTI Pte Ltd, Singapore (SG)

(72) Inventor: Chih-Feng Ho, Singapore (SG)

(21) Appl. No.: 18/644,141

(22) Filed: Apr. 24, 2024

(51) Int. Cl. F16M 13/02

(52) U.S. Cl. CPC F16M 13/02

(57) ABSTRACT

Disclosed is a fixation bracket that prevents overturn of a base and includes a fixation bracket that includes at least one connecting portion, a springing-back element, and a clamping member. The clamping member is connected to the springing-back element. The clamping member is provided with a bracing portion. When an external force moves or pushes away the clamping member, the springing-back element restores the clamping member back to a home position. By using the above-described structure in combination with a base of a supportive stand of a display device, fixing of the base of the supportive stand can be enhanced to prevent the display device from toppling down when acted upon by an external force, or to eliminate the need for replacing the supportive stand in case that the display device is replaced with a large-sized one. The effect of fixing can be enhanced by using the fixation bracket.

### BACKGROUND OF THE INVENTION

### (a) Technical Field of the Invention

The present invention relates to a fixation bracket, and more particularly to a fixation bracket that fixes a base in a strengthened manner.

### (b) Description of the Prior Art

As shown in FIG. 1, a known arrangement of supportive stand 100 and base 200 for displays are directly positionable on a desk to support the use of a display device 300. However, if hit by an external force, they may easily cause the display device 300 to topple down, resulting in damage of the display device 300 or causing undesired risks. Further, if the display device 300 is replaced with a large-sized one, the supportive stand 100 and the base 200 have to also change in order to ensure that the display device 300 would not get toppling down, while the original supportive stand 100 and the original base 200 are simply discarded. This causes a waste of resources. Further, fabrication is required for different sizes of the supportive stand 100 and the base 200 to suit the various sizes of the display device 300. This results in an increase of the fabrication cost.

### SUMMARY OF THE INVENTION

In view of the above problems, an objective of the present invention is to provide a fixation bracket that prevents overturn of a base.

To achieve the above objective, the present invention provides a base-overturn-preventing fixation bracket, which comprises:
a fixation bracket, wherein the fixation bracket comprises at least one connecting portion, a springing-back element, and a clamping member, wherein the clamping member is connected to the springing-back element, and the clamping member is provided with the bracing portion, wherein when an external force moves or pushes away the clamping member, the springing-back element restores the clamping member back to a home position.

By means of the above-described structure used in combination with a base of a supportive stand of a display device, securing of the base of the supportive stand can be enhanced to prevent the display device from toppling down when acted upon by an external force, or to eliminate the need for replacing the supportive stand in case that the display device is replaced with a large-sized one, and the effect of fixing can be enhanced by means of the fixation bracket.

### BRIEF DESCRIPTION OF THE DRAWINGS

FIG. 1 is a schematic view of the prior art.

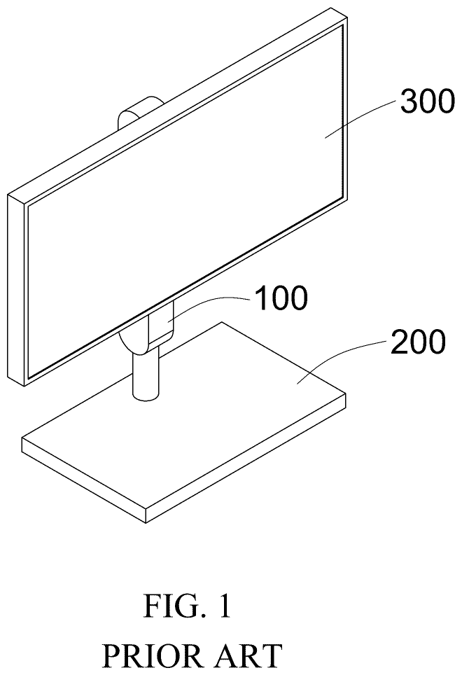

FIG. 2 is a schematic view showing a fixation bracket according to the present invention.

FIG. 3 is a schematic view showing the fixation bracket according to the present invention attached to a base.

FIG. 4 is a schematic view showing a clamping member being moved or pushed away according to the present invention.

FIG. 5 is a schematic view showing the clamping member being restored back according to the present invention.

### DETAILED DESCRIPTION OF THE PREFERRED EMBODIMENTS

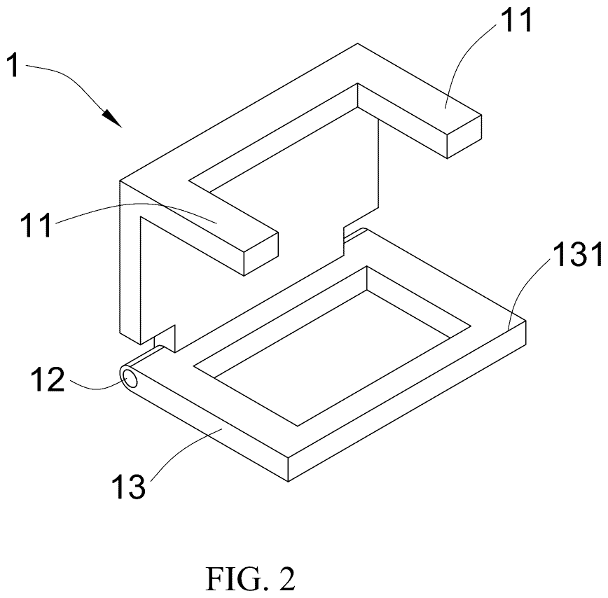

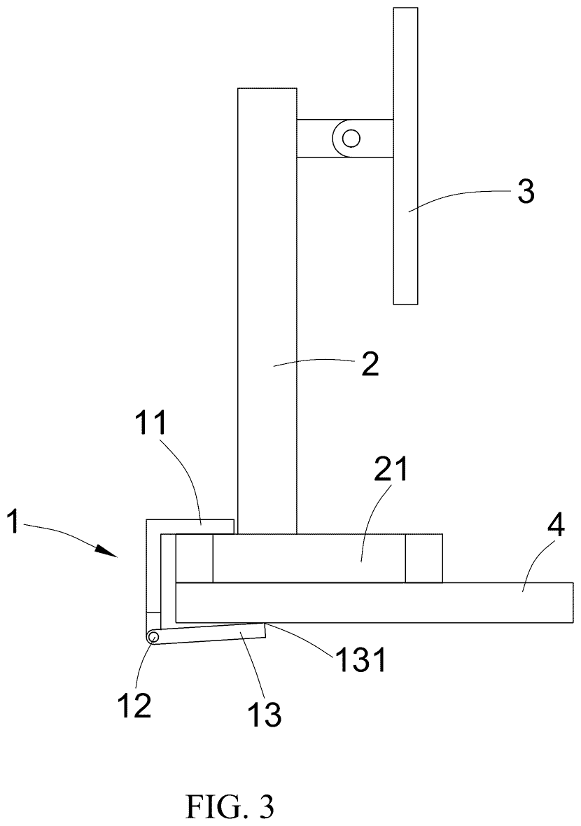

Referring to FIGS. 2 and 3, a base-overturn-preventing fixation bracket comprises: a fixation bracket 1, wherein the fixation bracket 1 comprises at least one connecting portion 11, a springing-back element 12, and a clamping member 13, wherein the clamping member 13 is connected to the springing-back element 12, and the clamping member 13 is provided with a bracing portion 131.

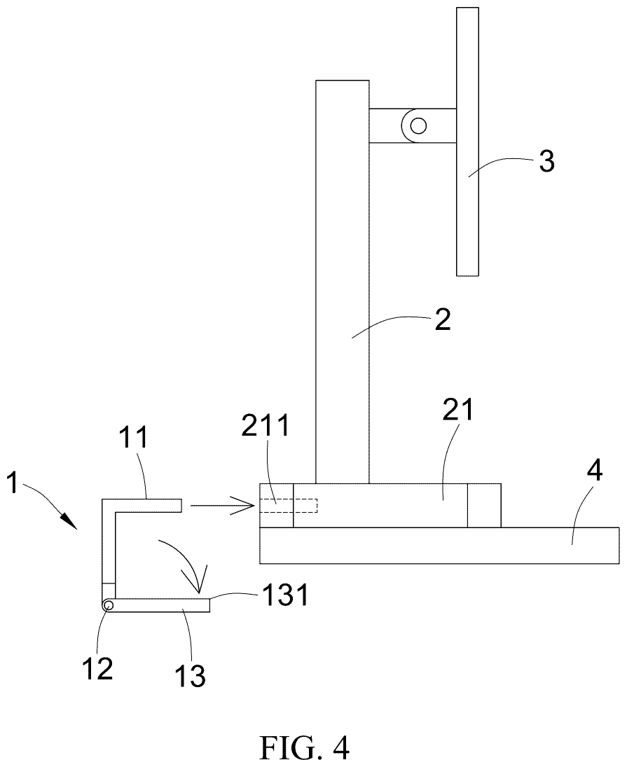

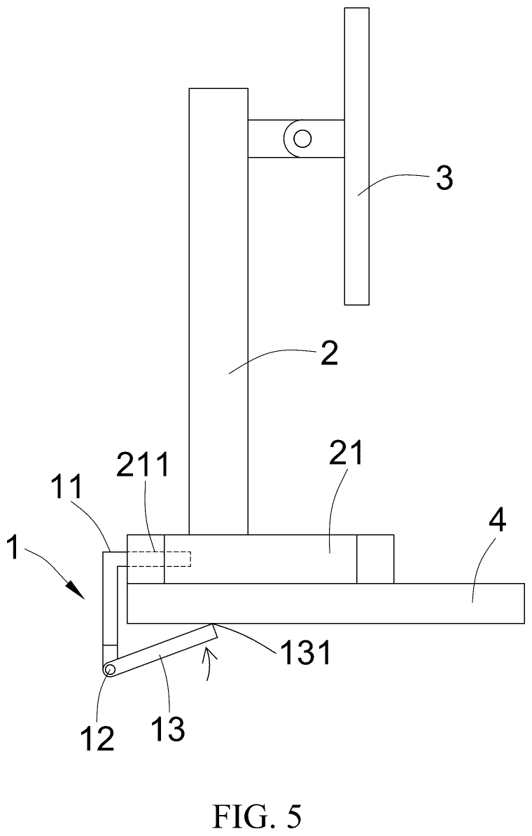

When an external force moves or pushes away the clamping member 13, the springing-back element 12 may cause the clamping member 13 to restore to a home position, as shown in FIGS. 4 and 5.

The springing-back element 12 may be an elastic element, and various elements can be implemented in the present invention, provided such elements may return or restore the clamping member 13, after the member being moved or pushed away by an external force, back to the home position.

The present invention is applicable to and usable in combination with a supportive stand 2 of a display device 3. The supportive stand 2 comprises a base 21, and the connecting portion 11 is directly disposed on the base 21, such that the supportive stand 2 can be fixed in position by the fixation bracket 1 in a strengthened manner.

Preferably, the base 21 is formed with at least one recessed trough 211, and the recessed trough 211 corresponds, in number, to the connecting portion 11, so that the connecting portion 11 is positionable in the recessed trough 211, as shown in FIG. 5.

Further referring to FIGS. 4 and 5, when the supportive stand 2 is placed at an edge of a desk 4, a force may be applied to move the clamping member 13 away and the connecting portion 11 of the fixation bracket 1 may then be positioned on the base 21 or in the recessed trough 211 of the base 21. Subsequently, the springing-back element 12 is allowed to move the clamping member 13 back to the home position to make the bracing portion 131 of the clamping member 13 bracing against an undersurface of the desk 4, so as to achieve an enhanced effect of fixing the supportive stand 2 and prevent the display device 3 from toppling down by an external force to result in damage or risk, or to make it not necessary to replace the supportive stand 2 in case that the display device 3 is replaced by a large-sized one for realizing an effect of preventing waste of resources.

By positioning the connecting portion 11 of the fixation bracket 1 on the base 21 of the supportive stand 2 on in the recessed trough 211 of the base 21, and also by allowing the springing-back element 12 and the clamping member 13 to brace against the desk 4, the base 21 of the supportive stand 2 can be secured in an enhanced manner to prevent the display device 3 from toppling down when acted upon by an external force or to eliminate the need for replacing the supportive stand 2 in case that the display device 3 is replaced by a large-sized one. The effect of fixing or securing can be enhanced by means of the fixation bracket 1, and, in addition, the present invention allows for easy mounting and removing, so that the present invention can be removed if there is no need to fix the supportive stand 2 in an enhanced manner, whereby the supportive stand 2 can be positioned on any flat surface and may not necessarily be placed at an edge of the desk 4 to thereby achieve an effect of easily changing as desired by the user and, for the fabrication of the supportive stand 2 and the base 21, there is no need to fabricate various ones of the supportive stand 2 and the base 21 to correspond to and match with various sizes of the display device 3.

I claim:

1. A base-overturn-preventing fixation bracket, comprising:
a fixation bracket, wherein the fixation bracket comprises at least one connecting portion, a springing-back element, and a clamping member, wherein the clamping member is connected to the springing-back element, and the clamping member is provided with a bracing portion.

2. The base-overturn-preventing fixation bracket according to claim 1, further comprising a supportive stand, the supportive stand comprising a base, the connecting portion being disposable on the base.

3. The base-overturn-preventing fixation bracket according to claim 2, wherein the base is formed with at least one recessed trough.

4. The base-overturn-preventing fixation bracket according to claim 1, wherein the springing-back element comprises an elastic element.
